(19) United States
(12) Patent Application Publication
(10) Pub. No.: US 2022/0072382 A1
(43) Pub. Date: Mar. 10, 2022

(54) METHODS, SYSTEMS, APPARATUSES, AND DEVICES FOR CORRECTING PLAYING ACTIONS PERFORMED BY A PLAYER FOR PLAYING A GAME

(71) Applicant: PowerMaxx Sports Inc., Pine Bush, NY (US)

(72) Inventors: Marshall Joseph Canosa, Pine Bush, NY (US); William Patrick Fraser, Poughkeepsie, NY (US); Marshall Anthony Canosa, Advance, NC (US); James Henry Telgheder, Slate Hill, NY (US)

(21) Appl. No.: 17/468,470

(22) Filed: Sep. 7, 2021

Related U.S. Application Data
(60) Provisional application No. 63/074,648, filed on Sep. 4, 2020.

(51) Int. Cl. A63B 24/00; A63B 71/06

(52) U.S. Cl. CPC A63B 24/0075; A63B 24/0062; A63B 2220/805; A63B 2071/0627; A63B 71/0622

(57) ABSTRACT

Disclosed herein is an apparatus for correcting playing actions performed by a player for playing a game, in accordance with some embodiments. Accordingly, the apparatus comprises sensors, a processing device, and an output device. Further, a first sensor generates first sensor data based on detecting a passing of a first body part through a first sensor field of view and a second sensor generates second sensor data based on detecting a passing of a second body part through a second sensor field of view. Further, the processing device analyzes the first sensor data and the second sensor data, recognizes the first body part in a first area and the second body part in a second area, determines a presence of the first body part and the second body part, determines a correctness of a playing action, and generates a cueing command. Further, the output device produces a cue.

The current application claims a priority to the U.S. Provisional Patent application Ser. No. 63/074,648 filed on Sep. 4, 2020. The current application is filed on Sep. 7, 2021, whereas Sep. 4, 2021, and Sep. 5, 2021 were on a weekend, and whereas Sep. 6, 2021 was on a national holiday (Labor Day).

### FIELD OF THE INVENTION

Generally, the present disclosure relates to the field of amusement devices: games. More specifically, the present disclosure relates to methods, systems, apparatuses, and devices for correcting playing actions performed by a player for playing a game.

### BACKGROUND OF THE INVENTION

Existing techniques for correcting playing actions performed by a player for playing a game are deficient with regard to several aspects. For instance, current technologies do not. Furthermore, current technologies do not measure correct or incorrect pitching, hitting, and throwing mechanics in the game of baseball/softball by using audible, silent, and visual cues to alert players or instructors to correct incorrect techniques. Moreover, current technologies do not resolve a problem of going too fast to home plate during the pitching motion specifically and moving toward any target in a less, kinetically efficient manner. Furthermore, current technologies do not resolve a problem of players stepping too fast towards the pitcher while hitting.

Therefore, there is a need for improved methods, systems, apparatuses, and devices for correcting playing actions performed by a player for playing a game that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is an apparatus for correcting playing actions performed by a player for playing a game, in accordance with some embodiments. Accordingly, the apparatus may include a plurality of sensors, a processing device, and at least one output device. Further, the plurality of sensors may include a first sensor and a second sensor. Further, the first sensor may be associated with a first sensor field of view and the second sensor may be associated with a second sensor field of view. Further, the first sensor field of view covers a first area and the second sensor field of view covers a second area. Further, at least one first body part of the player may be required to pass through the first area and at least one second body part of the player may be required to pass through the second area for performing a playing action. Further, the first sensor may be configured for generating first sensor data based on detecting a passing of the at least one first body part of the player through the first sensor field of view. Further, the second sensor may be configured for generating second sensor data based on detecting a passing of the at least one second body part of the player through the second sensor field of view. Further, the processing device may be communicatively coupled with the plurality of sensors. Further, the processing device may be configured for analyzing the first sensor data and the second sensor data. Further, the processing device may be configured for recognizing the at least one first body part of the player in the first area and the at least one second body part of the player in the second area. Further, the processing device may be configured for determining a presence of the at least one first body part in the first area and the at least one second body part in the second area under at least one criterion based on the recognizing. Further, the processing device may be configured for determining a correctness of the playing action based on the determining of the presence. Further, the processing device may be configured for generating at least one cueing command based on the determining. Further, the at least one output device may be communicatively coupled with the processing device. Further, the at least one output device may be configured for producing at least one cue to inform the player about the correctness of the playing action based on the at least one cue command.

Further disclosed herein is an apparatus for correcting playing actions performed by a player for playing a game, in accordance with some embodiments. Accordingly, the apparatus may include a plurality of sensors, a processing device, a storage device, and at least one output device. Further, the plurality of sensors may include a first sensor and a second sensor. Further, the first sensor may be associated with a first sensor field of view and the second sensor may be associated with a second sensor field of view. Further, the first sensor field of view covers a first area and the second sensor field of view covers a second area. Further, at least one first body part of the player may be required to pass through the first area and at least one second body part of the player may be required to pass through the second area for performing a playing action. Further, the first sensor may be configured for generating first sensor data based on detecting a passing of the at least one first body part of the player through the first sensor field of view. Further, the second sensor may be configured for generating second sensor data based on detecting a passing of the at least one second body part of the player through the second sensor field of view. Further, the processing device may be communicatively coupled with the plurality of sensors. Further, the processing device may be configured for analyzing the first sensor data and the second sensor data. Further, the processing device may be configured for recognizing the at least one first body part of the player in the first area and the at least one second body part of the player in the second area. Further, the processing device may be configured for determining a presence of the at least one first body part in the first area and the at least one second body part in the second area under at least one criterion based on the recognizing. Further, the processing device may be configured for determining a correctness of the playing action based on the determining of the presence. Further, the processing device may be configured for generating at least one cueing command based on the determining. Further, the processing device may be configured for generating review data for the playing action using the first sensor data and the second sensor data based on the determining of the correctness. Further, the storage device may be communicatively coupled with the processing device. Further, the storage device may be configured for storing the review data. Further, the review data may include an indication of the correctness. Further, the at least one output device may be communicatively coupled with the processing device. Further, the at least one output device may be configured for producing at least one cue to inform the player about the correctness of the playing action based on the at least one cue command.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a front perspective view of an apparatus for correcting playing actions performed by a player for playing a game, in accordance with some embodiments.

FIG. 2 is a front perspective view of the apparatus, in accordance with some embodiments.

FIG. 3 is a front perspective view of the apparatus, in accordance with some embodiments.

FIG. 4 is a front perspective view of the apparatus, in accordance with some embodiments.

FIG. 5 is a front perspective view of the apparatus, in accordance with some embodiments.

FIG. 6 is a front perspective view of the apparatus, in accordance with some embodiments.

FIG. 7 is an exploded view of an apparatus for correcting playing actions performed by a player for playing a game, in accordance with some embodiments.

FIG. 8 is a side perspective view of the apparatus, in accordance with some embodiments.

FIG. 9 is a side view of the apparatus, in accordance with some embodiments.

FIG. 10 is a top view of the apparatus, in accordance with some embodiments.

FIG. 11 is a rear perspective view of the upper body sensor tube of the apparatus, in accordance with some embodiments.

FIG. 12 is a rear perspective view of the lower body sensor tube of the apparatus, in accordance with some embodiments.

FIG. 13 is a front perspective view of a tube adjustment assembly of the apparatus, in accordance with some embodiments.

FIG. 14 is a front perspective view of a bracket hinge assembly of the apparatus, in accordance with some embodiments.

FIG. 15 is a crossectional view of a chassis assembly of the apparatus, in accordance with some embodiments.

FIG. 16 is a side view of an adjustment screw of the apparatus, in accordance with some embodiments.

FIG. 17 is a front perspective view of an apparatus for correcting playing actions performed by a player for playing a game, in accordance with some embodiments.

FIG. 18 is an illustration of an online platform consistent with various embodiments of the present disclosure.

FIG. 19 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for correcting playing actions performed by a player for playing a game, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods, systems, apparatuses, and devices for correcting playing actions performed by a player for playing a game. The present invention will measure correct or incorrect pitching, hitting, and throwing mechanics in the game of baseball/softball by using audible, silent, and visual cues to alert the participant or instructor to correct incorrect techniques. The present invention can also be used to detect the form and mechanics of a user's (player's) golf or tennis swing, lacrosse throw, and other ball-based sports. It will identify the problem of going too fast to home plate during the pitching motion specifically and moving toward any target in a less kinetically efficient manner. This action of moving towards home plate too quickly is called “rushing”. Also, the device will identify the problem of the user (player) stepping too fast towards the pitcher while hitting. This is called “lunging”. The audible, silent, and visual sensors are set at two different places. One sensor is set at the hip/shoulder/waist area and the other sensor is focused on the lower leg. The two sensors will activate in sequence when the pitcher or hitter goes through the entire pitching/hitting motion. The sensors possess different sounds and/or different visual indicators. The lead foot of the user and the hip/shoulder area of the user passes through the respective sensor fields and has the ability to measure hip/shoulder ground force separation. If the lead foot activates the sensor that is aimed at foot first and the hip/shoulder area activates the sensor aimed at the hip/shoulder area second, the device has shown the user has properly activated the device with a distinct, discernible time between the activation of the two sensors, the user has performed the pitching, batting or any other throwing motion with proper mechanics. The unit is designed to measure time and detect presence from two different parts of the body. The difference in time from when the user's front foot hits the ground and the upper body finishes the trial and follows through. If the time difference is within a defined narrow window, the user will be at his/her greatest kinetic efficiency and will have the least stress on his arm/shoulder. Keeping the weight of the participant in the proper starting position and then transferring the weight from back to front sequentially is important to maximize the potential of the user performing the pitching, hitting, or throwing skill. With two sensors and two different sounds, the user and the user's instructor will have immediate feedback on the proper sequence. It can be used in pitching, hitting, or any other ball based application. The device is portable, easy to use, and easy to set up, can use batteries or electricity, and can be used indoors or outdoors by one person.

The front of the device is comprised of a dual-purpose front cover/back support swing arm that is initially fixed to cover then swings to become a support front to back and to prevent damage during transport of the device. This may or may not be needed. During normal operation, magnets or other locking mechanisms may be used to keep the cover in place such as a cover plate component and can swing around to act as a support stand or stability component including adjusting the tilt of the unit to improve its performance. It has a leveling vial on the top of the device to level the device and to set it up properly on uneven surfaces and ensure consistent readings. The device is adjusted by two adjustable leveling feet at the bottom of the device on each side of the device which may be or may not be used to help level the device. One sensor is designed to pivot up and down to help aim the sensor at the spot where the front foot will strike the ground. The other sensor also pivots up and down for aiming to accommodate the height of different athletes and to accommodate for the distance away from foot strike. Each sensor has a laser mounted on the sensor tube and is activated during setup mode to identify each measuring spot. The laser can be turned off or left on when measuring. The device has adjustment knobs that will adjust each sensor/laser. A time stamp millisecond timer is located under both sensors that give the user a specific time value, to the millisecond. The device is designed to be placed on the ground/floor to the left of the user as the user faces a target a distance away from the front foot strike of the user as he/she moves toward the target. One sensor activates when the user strikes the sensor field with his front foot. The other sensor activates sequentially after the first sensor activates. There is a set of three switches. Each can be activated manually or remotely. A discreet power switch can be powered manually or remotely, a laser switch discreetly turns on and/or off manually or remotely, and a sound switch that turns on or off manually or remotely. The sound is turned on either manually or remotely and runs through a speaker and emits a monotone, blinking dashes, or any other warning modality when the unit is improperly activated or two different tones when the unit is properly activated and a successful trial has been achieved. Different color ready lights allow the user to know when he/she can begin the next trial. In the event that atrial takes more than the allotted time to complete, the trial will be incomplete and no time will be recorded and an error message will present itself on the display. If the sensor that measures the foot strike detects the presence and the other sensor does not register within a certain time interval, the trial will not record a time and will be invalid. Once the sensor that detects foot strike detects presence, a timer mechanism is triggered in the firmware and when the other sensor detects presence in the upper body area it is also triggered. The value that is captured between the two sensors is displayed on the seven-segment display and is communicated in a numerical value. On the back of the device is a power supply port to allow the device to be operated electrically, and a battery compartment to allow batteries to be used to power the unit.

There is a seven second delay so as to allow the user to reset his position and for the device to reset the timing mechanism. To achieve optimum results for detecting form, the one sensor must be adjusted so that the sensor beam strikes the area where the foot strikes the ground and the other sensor strikes the user's body above the waist but not above the shoulder.

If the time registered between the sensors is too short, the user will know and then correct it. If the time between the sensors is too long, the user will know and then correct it. Both “lunging” (hitters) and “rushing” (pitchers) are not acceptable forms and result in low efficiency hits and pitches.

The device will also have a Bluetooth transceiver that is used to communicate with a mobile app or a website on a user's device. The mobile app/website will keep track of each trial and will support tracking of the trials and their specifics such as time stamp, date stamp, Device values, number of trials, and all other metrics defined by the device that will be value added to the unit.

Alternative embodiments of the device may include sensing technology that may be used in the device. This sensing technology may include, but is not limited to, a single sensing technology or the combination of technologies such as optical technology such as infrared, laser, LIDAR; acoustic; image recognition; cameras; machine learning; artificial intelligence; radar gun readout capability; a remote (sensor) using one or more cameras or recording devices (triangulation) with or without a radar gun; wearable augmented reality device without a radar gun; a repository database with analytics to store and process the data from the aforementioned features; and Bluetooth connectivity, infrared technology, motion technology, and Wi-Fi capability. The device may also be used in conjunction with a handheld monitoring device (smartphone, etc.) that observers, coaches, and similar users may use for the aforementioned features. The electronic monitoring device allows a user to monitor, as well as store, all data such as spin rate, launch angle, exit velocity, speed from any of the previously mentioned modalities (radar gun, cameras, recording devices, augmented reality devices, and any other data gathering device used in conjunction with the device).

During the course of a training session or a live game, it is very difficult for the user to notice and assess patterns and trends in his/her performance. The device allows the user a number of options while using the device to assess performance and correct any mistakes. One option allows the device to correct mistakes in real time with instant feedback. A second option would be to use the data provided by the two sensors, cameras, and/or recording devices and radar guns to store data in a repository database to allow the user to review and analyze the data following the training session or game. The database stores data drawn from the previously mentioned devices and allows the user to retrieve any and all data pertaining to the user's performance. The data can be stored on the user's computer or portable device and can be stored and retrieved via an application specifically designed to be used with a computer or other portable device (tablet, smartphone, etc.). The user will be able to view statistics, metrics, personal progress, and historical trends. Conclusions drawn will allow the user guidance on possible improvements and to help with the efficiency of subsequent training sessions.

Further, the present disclosure relates generally to an apparatus for a baseball and softball pitching, hitting, and throwing aid device. More specifically, the present disclosure describes an apparatus for a baseball and softball pitching, hitting, and throwing aid device that uses sensing technology elicit auditory, silent, and visual cues to measure proper technique while pitching, hitting, and throwing.

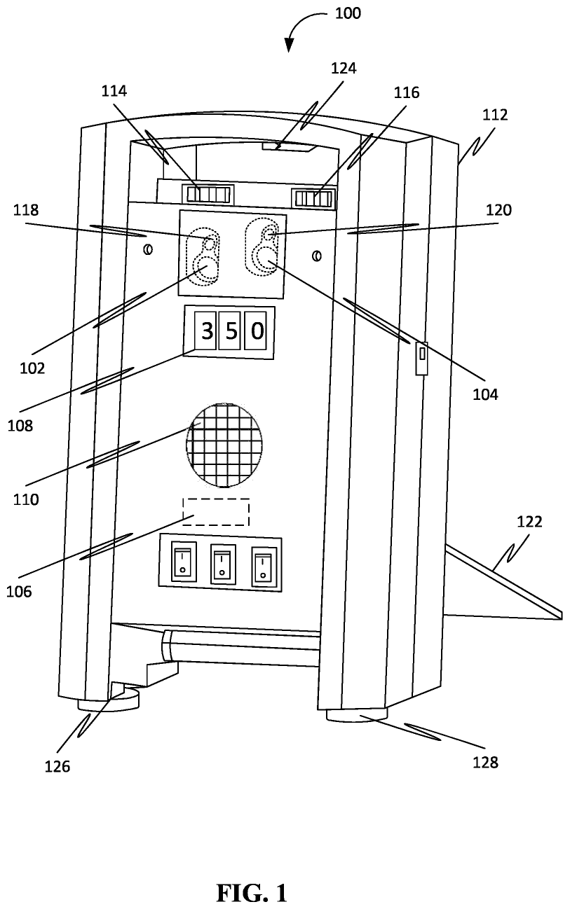

FIG. 1 is a front perspective view of an apparatus 100 for correcting playing actions performed by a player for playing a game, in accordance with some embodiments.

Accordingly, the apparatus 100 may include a plurality of sensors 102-104, a processing device 106 (such as PCB 710), and at least one output device 108-110. Further, the game may include ball based games such as baseball, softball, golf, cricket, tennis, table tennis, lacrosse, and so on. Further, the playing actions may include pitching, hitting, batting, lacrosse throw, golf swing, tennis swing, etc.

Further, the plurality of sensors 102-104 may include a first sensor 102 and a second sensor 104. Further, the first sensor 102 may be associated with a first sensor field of view and the second sensor 104 may be associated with a second sensor field of view. Further, the first sensor field of view covers a first area and the second sensor field of view covers a second area. Further, at least one first body part of the player may be required to pass through the first area and at least one second body part of the player may be required to pass through the second area for performing a playing action. Further, the at least one first body part may include a foot of the player. Further, the first sensor 102 may be configured for generating first sensor data based on detecting a passing of the at least one first body part of the player through the first sensor field of view. Further, the at least one second body part may include at least one of a hip and a shoulder of the player. Further, the second sensor 104 may be configured for generating second sensor data based on detecting a passing of the at least one second body part of the player through the second sensor field of view.

Further, the processing device 106 may be communicatively coupled with the plurality of sensors 102-104. Further, the processing device 106 may be configured for analyzing the first sensor data and the second sensor data. Further, the processing device 106 may be configured for recognizing the at least one first body part of the player in the first area and the at least one second body part of the player in the second area. Further, the processing device 106 may be configured for determining a presence of the at least one first body part in the first area and the at least one second body part in the second area under at least one criterion based on the recognizing. Further, the at least one criterion may include a sequence of the presence of the at least one first body part in the first area and the at least one second body part in the second area, a time interval between the presence of the at least one first body part in the first area and the at least one second body part in the second area, an orientation of the at least one first body part in the first area and the at least one second body part in the second area, etc. Further, the processing device 106 may be configured for determining a correctness of the playing action based on the determining of the presence. Further, the processing device 106 may be configured for generating at least one cueing command based on the determining.

Further, the at least one output device 108-110 (such as a speaker 712, a display, etc.) may be communicatively coupled with the processing device 106. Further, the at least one output device 108-110 may be configured for producing at least one cue to inform the player about the correctness of the playing action based on the at least one cue command. Further, the at least one cue may include an auditory cue, a silent cue, a visual cue, etc.

In further embodiments, the apparatus 100 may include an apparatus body 112 (back cover 730 and the front cover 732) of the apparatus 100. Further, the apparatus body 112 may be disposable on at least one surface. Further, at least one of the plurality of sensors 102-104, the processing device 106, and the at least one output device 108-110 may be disposed in the apparatus body 112.

Further, in an embodiment, the plurality of sensors 102-104 may be pivotally disposed in the apparatus body 112. Further, the plurality of sensors 102-104 may be configured to be pivoted between a plurality of sensor positions using a plurality of pivoting mechanisms 114-116 (such as adjustment knobs, one or more tube adjustment knobs 702-704, etc.). Further, the first sensor field of view covers the first area based on pivoting the first sensor 102 to a first sensor position of the plurality of sensor positions. Further, the second sensor field of view covers the second area based on pivoting the second sensor 104 to a second sensor position of the plurality of sensor positions. In further embodiments, the apparatus 100 may include a communication device 202 configured for receiving player data associated with the player from at least one input device. Further, the player data may include at least one measurement of the player. Further, the at least one measurement may include a height of the player, a weight of the player, a stride length of the player, a length of legs of the player, etc. Further, the communication device 202 may be communicatively coupled with the processing device 106. Further, the processing device 106 may be configured for analyzing the player data based on at least one playing action criterion. Further, the processing device 106 may be configured for determining the first area and the second area based on the analyzing of the player data. Further, the processing device 106 may be configured for generating a plurality of sensor commands for the plurality of sensors 102-104 based on the determining of the first area and the second area. Further, the processing device 106 may be communicatively coupled with a plurality of actuators 204-206. Further, the plurality of actuators 204-206 may be operationally coupled with the plurality of pivoting mechanisms 114-116. Further, the plurality of actuators 204-206 may be configured for actuating the plurality of pivoting mechanisms 114-116 based on the plurality of sensor commands. Further, the plurality of pivoting mechanisms 114-116 may be configured for pivoting the plurality of sensors 102-104 based on the actuating.

In further embodiments, a plurality of laser devices 118-120 may be disposed in the apparatus body 112. Further, a first laser device 118 of the plurality of laser devices 118-120 may be configured for pointing the first area for identifying the first area. Further, a second laser device 120 of the plurality of laser devices 118-120 may be configured for pointing the second area for identifying the second area. Further, the pivoting of the first sensor 102 to the first sensor position may be based on the identifying of the first area. Further, the pivoting of the second sensor 104 to the second sensor position may be based on the identifying of the second area.

In further embodiments, a support stand 122 (such as a cover plate, the bracket 728, etc.) may be pivotally attached to a rear portion of the apparatus body 112. Further, the support stand 122 may be configured to be pivoted between a closed position and at least one open position in relation to the rear portion. Further, the support stand 122 extends away from the rear portion in the at least one open position. Further, the support stand 122 may be positioned on the rear portion in the closed position. Further, the support stand 122 in the at least one open position may be configured for inclinably supporting the apparatus body 112 in at least one inclination on the at least one surface. Further, the at least one inclination corresponds to the at least one open position.

In further embodiments, a leveling vial 124 (such as leveling bulb 724) may be disposed on a top portion of the apparatus body 112. Further, the leveling vial 124 may be configured for indicating a tilt of the apparatus body 112 in relation to the at least one surface for adjusting the tilt of the apparatus body 112 in relation to the at least one surface. In further embodiments, one or more adjustable leveling feet 126-128 may be disposed on a bottom portion of the apparatus body 112. Further, the one or more adjustable leveling feet 126-128 may be transitionable between a plurality of feet states. Further, the adjusting of the tilt of the apparatus body 112 may be based on transitioning the one or more adjustable leveling feet 126-128 to at least one feet state of the plurality of feet states.

In further embodiments, a timer mechanism 302 may be communicatively coupled with the plurality of sensors 102-104. Further, the timer mechanism 302 may be configured for registering a first time value based on the detecting of the passing of the at least one first body part of the player. Further, the timer mechanism 302 may be configured for registering a second time value based on the detecting of the passing of the at least one second body part of the player. Further, the processing device 106 may be communicatively coupled with the timer mechanism 302. Further, the processing device 106 may be configured for analyzing the first time value and the second time value. Further, the processing device 106 may be configured for determining a time interval between the first time value and the second time value based on the analyzing of the first time value and the second time value. Further, the at least one criterion may include the time interval. Further, the determining of the presence of the at least one first body part of the player in the first area and the at least one second body part of the player in the second area under the at least one criterion may be further based on the determining of the time interval.

Further, in some embodiments, the processing device 106 may be configured for generating review data for the playing action using the first sensor data and the second sensor data based on the determining of the correctness. Further, the review data may include an indication of the correctness. Further, the processing device 106 may be communicatively coupled with a storage device 402. Further, the storage device 402 may be configured for storing the review data.

In further embodiments, a communication device 502 may be communicatively coupled with the storage device 402. Further, the communication device 502 may be configured for transmitting the review data to at least one device.

In further embodiments, a storage device 602 may be configured for retrieving correct playing action data associated with the playing action. Further, the processing device 106 may be communicatively coupled with the storage device 602. Further, the processing device 106 may be configured for analyzing the correct playing action data. Further, the processing device 106 may be configured for determining the at least one criterion may be further based on the analyzing the correct playing action data. Further, the determining of the presence of the at least one first body part of the player in the first sensor field of view and the at least one second body part of the player in the second sensor field of view under the at least one criterion may be further based on the determining of the at least one criterion. In further embodiments, a communication device 604 may be configured for receiving player data associated with the player from at least one input device. Further, the player data may include at least one measurement of the player. Further, the communication device 604 may be communicatively coupled with the processing device 106. Further, the processing device 106 may be configured for analyzing the player data. Further, the determining of the at least one criterion may be based on the analyzing of the correct playing action data and the analyzing the player data.

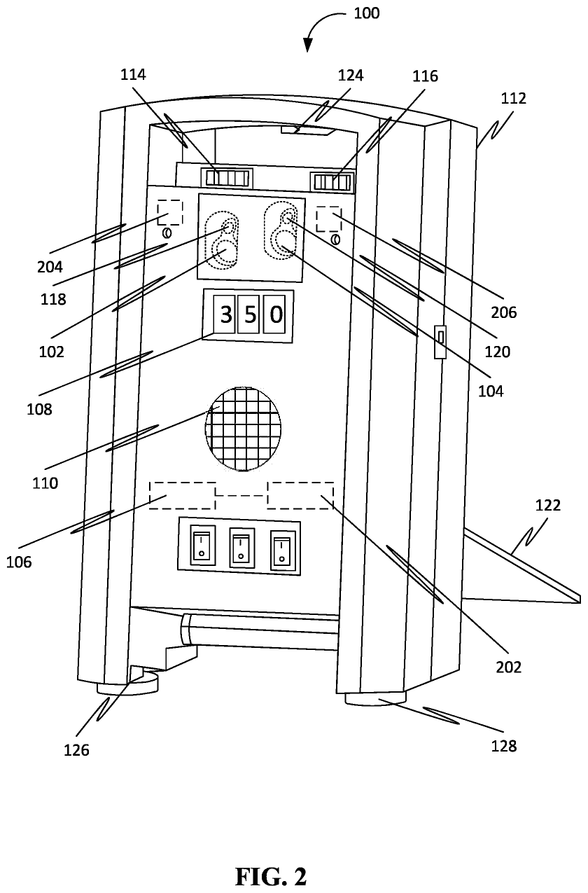

FIG. 2 is a front perspective view of the apparatus 100, in accordance with some embodiments.

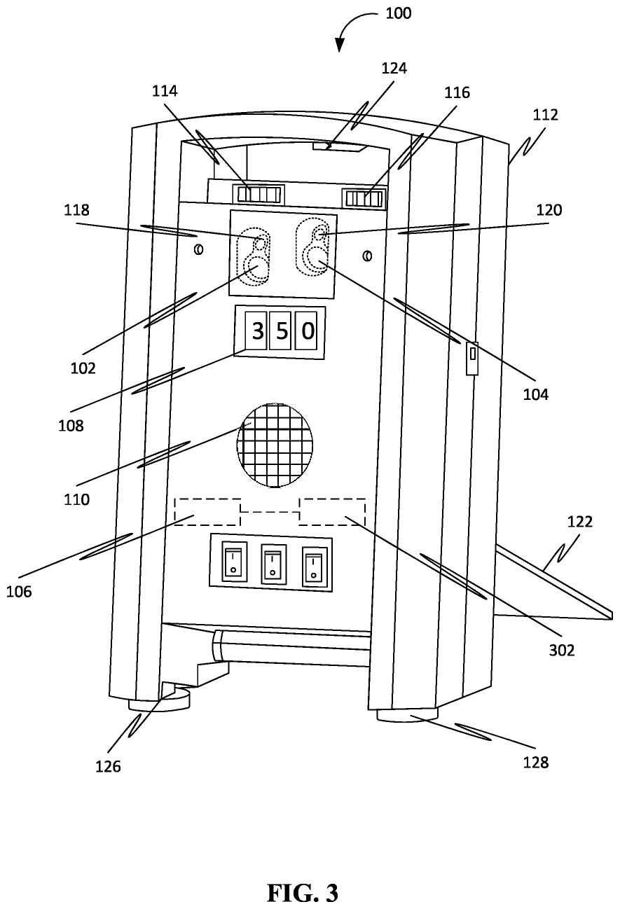

FIG. 3 is a front perspective view of the apparatus 100, in accordance with some embodiments.

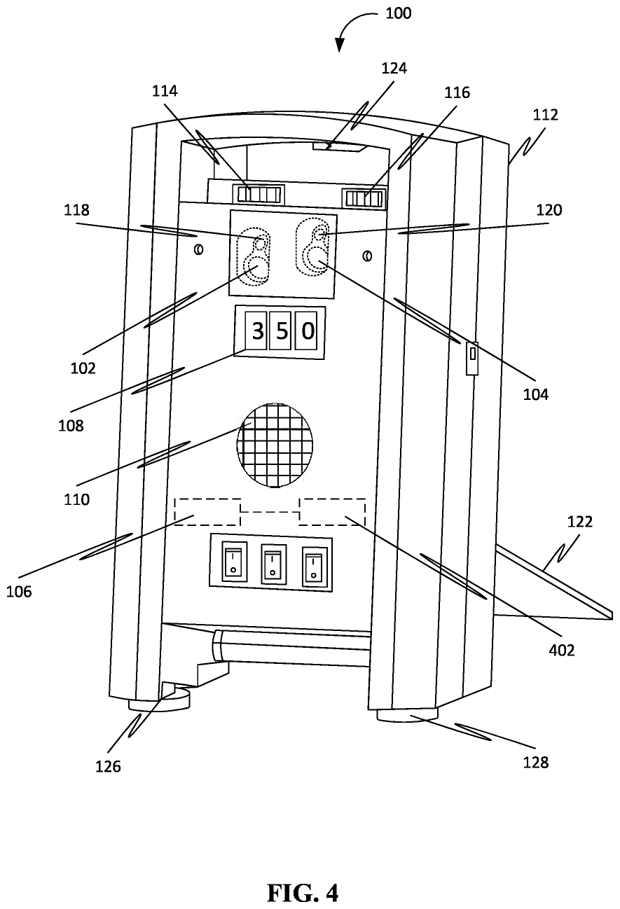

FIG. 4 is a front perspective view of the apparatus 100, in accordance with some embodiments.

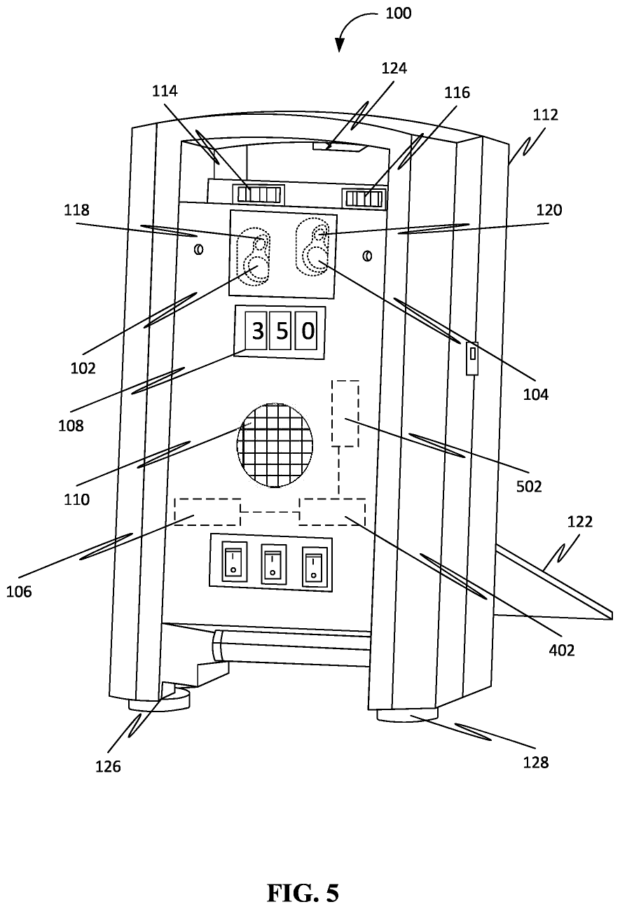

FIG. 5 is a front perspective view of the apparatus 100, in accordance with some embodiments.

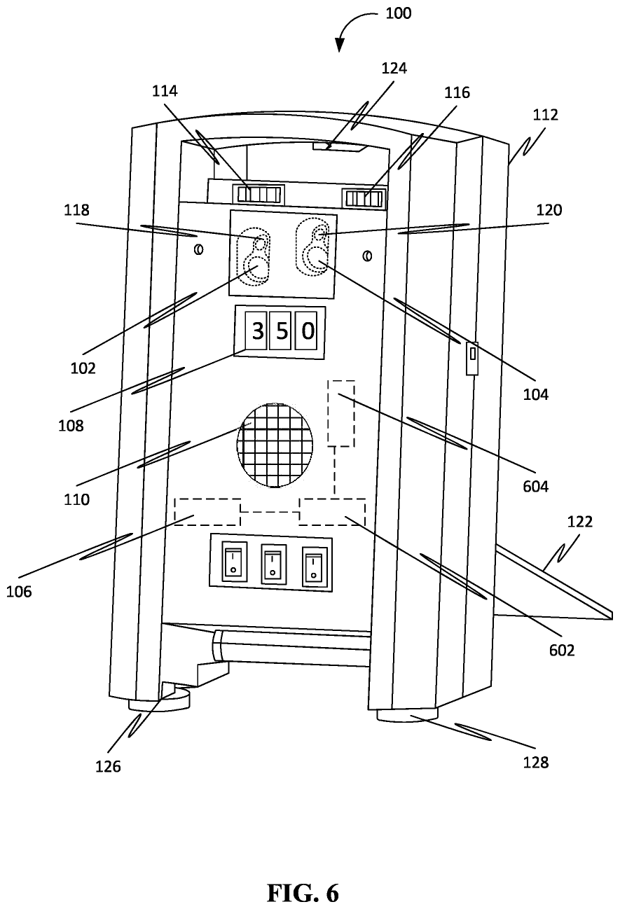

FIG. 6 is a front perspective view of the apparatus 100, in accordance with some embodiments.

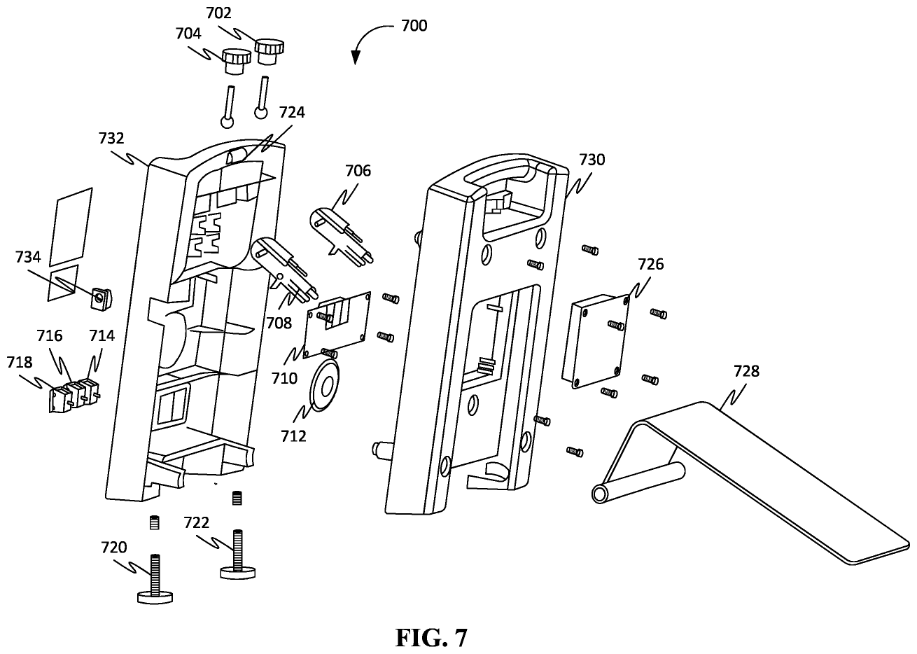

FIG. 7 is an exploded view of an apparatus 700 for correcting playing actions performed by a player for playing a game, in accordance with some embodiments. Further, the apparatus 700 may include one or more tube adjustment knobs 702-704, one or more laser/sensor tubes 706-708, a PCB 710, a speaker 712, one or more switches 714-718, one or more leveling feet 720-722, a leveling bulb 724, a battery pack 726, a bracket (stand) 728, a back cover 730, a front cover 732, and a charging port 734. Further, the apparatus 700 may include sensors and lasers (laser devices) housed in the one or more laser/sensor tubes 706-708. Further, a breadth of the apparatus 700 may be 180 mm, a height of the apparatus 700 is 297 mm, an apparent height is 290 mm, and a width of the apparatus 700 is 84 mm.

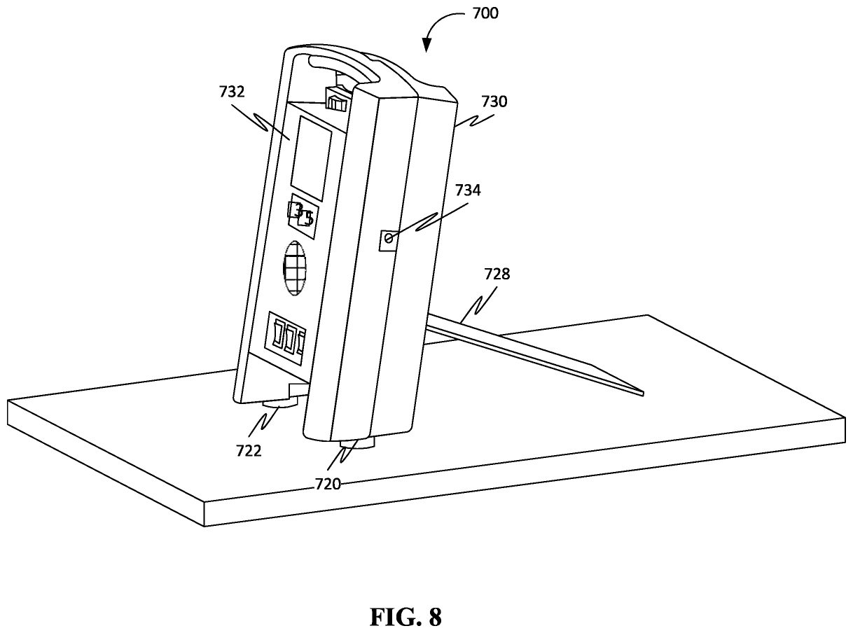

FIG. 8 is a side perspective view of the apparatus 700, in accordance with some embodiments. FIG. 8 is an assembled view of the apparatus 700.

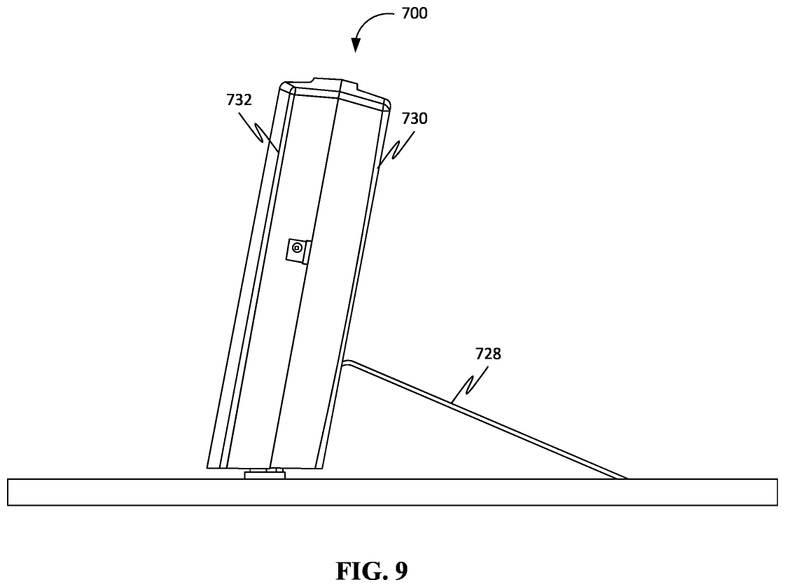

FIG. 9 is a side view of the apparatus 700, in accordance with some embodiments.

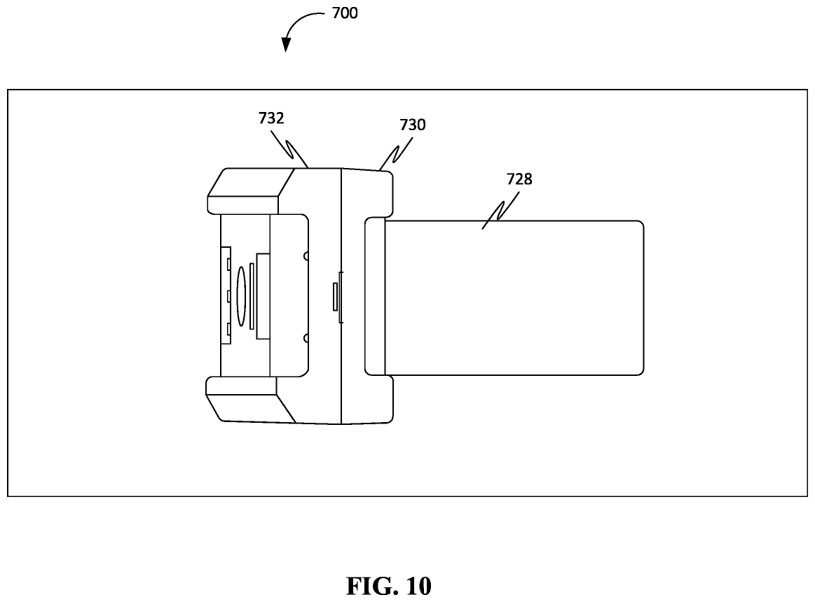

FIG. 10 is a top view of the apparatus 700, in accordance with some embodiments.

Further

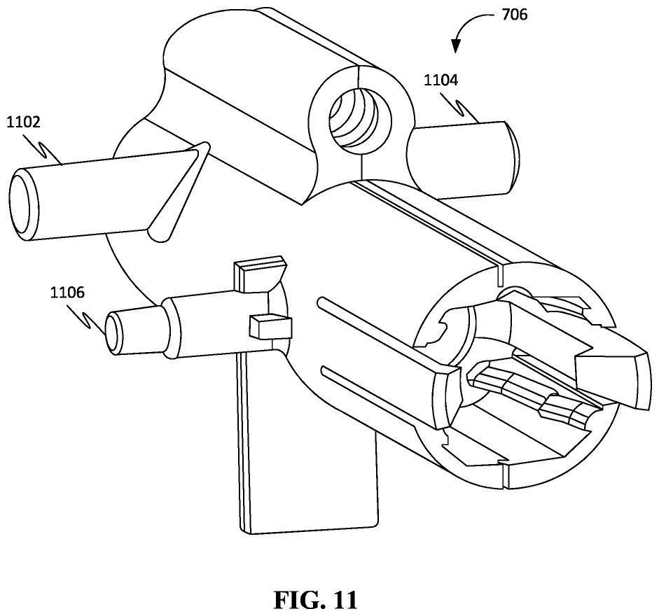

FIG. 11 is a rear perspective view of the upper body sensor tube 706 of the apparatus 700, in accordance with some embodiments. Further, the upper body sensor tube 706 may include one or more pivot ears 1102-1104 and a tube adjustment arm 1106.

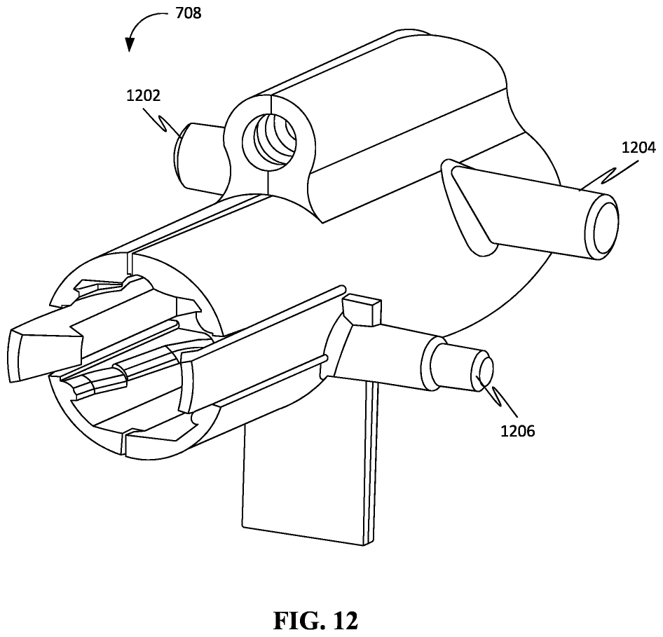

FIG. 12 is a rear perspective view of a lower body sensor tube 708 of the apparatus 700, in accordance with some embodiments. Further, the lower body sensor tube 708 may include one or more pivot ears 1202-1204 and a tube adjustment arm 1206.

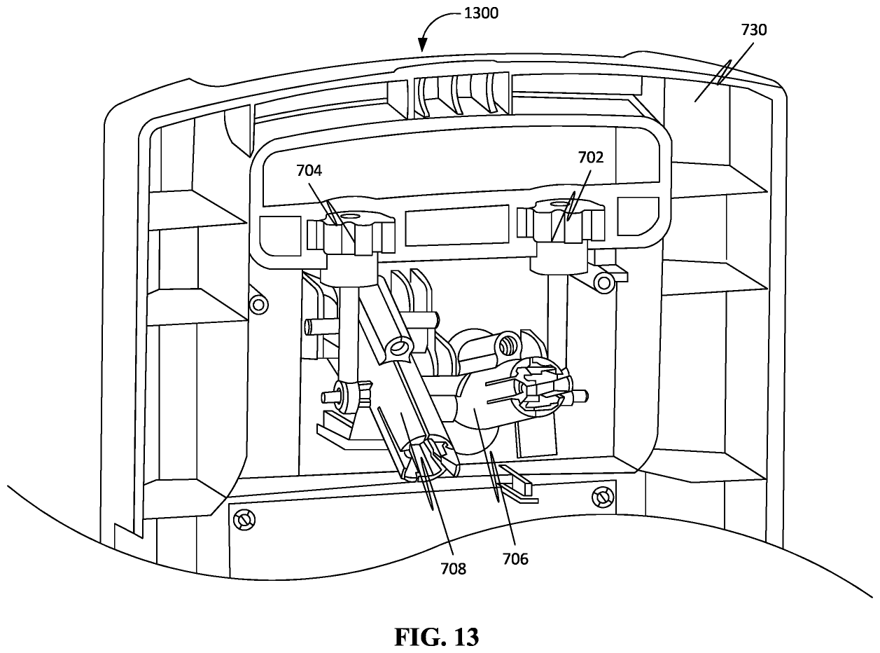

FIG. 13 is a front perspective view of a tube adjustment assembly 1300 of the apparatus 700, in accordance with some embodiments.

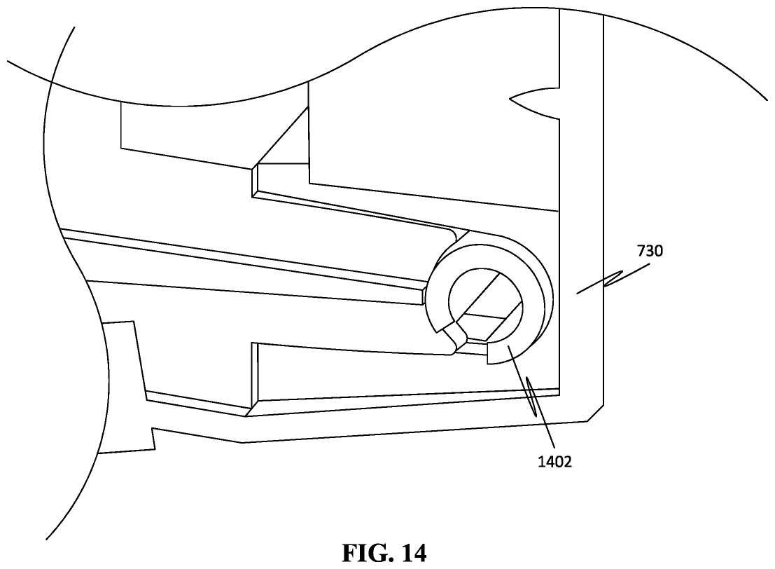

FIG. 14 is a front perspective view of a bracket hinge assembly 1402 of the apparatus 700, in accordance with some embodiments.

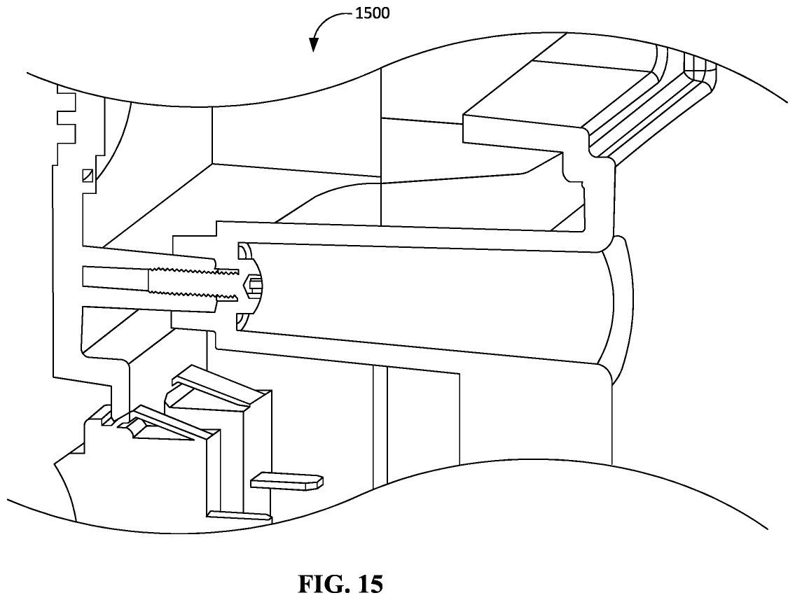

FIG. 15 is a crossectional view of a chassis assembly 1500 of the apparatus 700, in accordance with some embodiments.

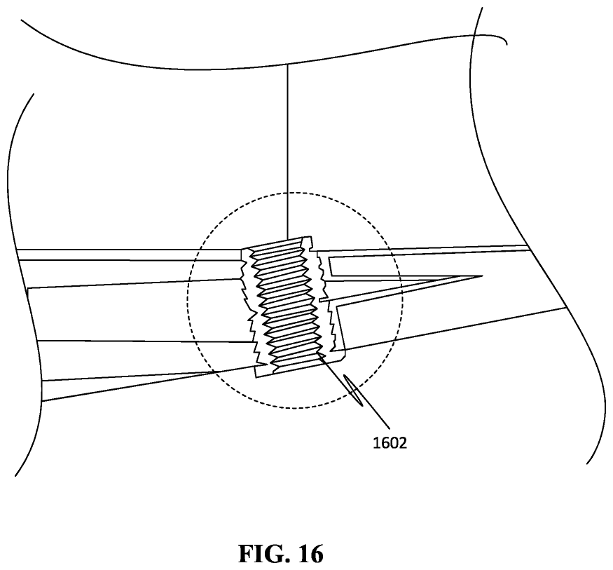

FIG. 16 is a side view of an adjustment screw 1602 of the apparatus 700, in accordance with some embodiments.

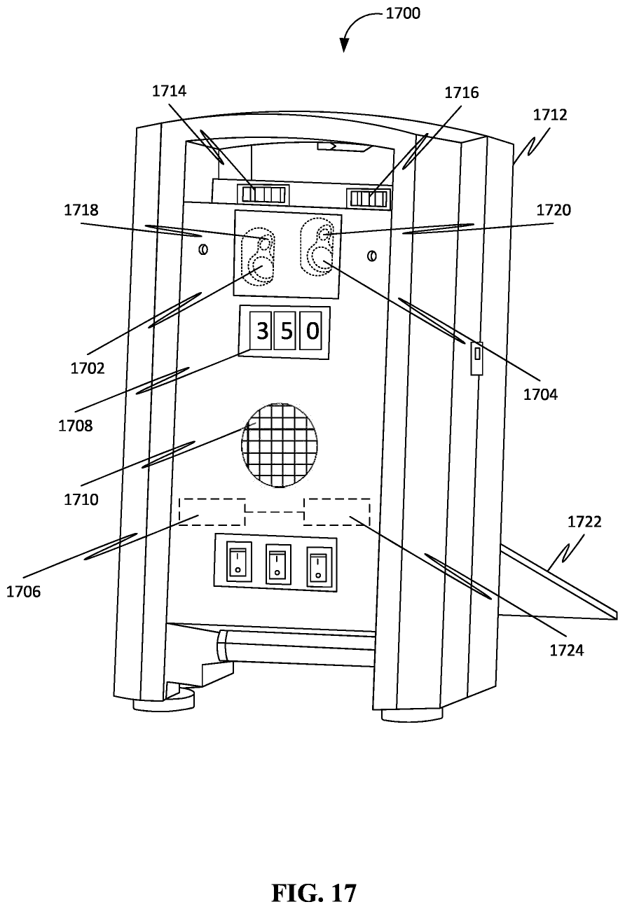

FIG. 17 is a front perspective view of an apparatus 1700 for correcting playing actions performed by a player for playing a game, in accordance with some embodiments. Accordingly, the apparatus 1700 may include a plurality of sensors 1702-1704, a processing device 1706, a storage device 1724, and at least one output device 1708-1710.

Further, the plurality of sensors 1702-1704 may include a first sensor 1702 and a second sensor 1704. Further, the first sensor 1702 may be associated with a first sensor field of view and the second sensor 1704 may be associated with a second sensor field of view. Further, the first sensor field of view covers a first area and the second sensor field of view covers a second area. Further, at least one first body part of the player may be required to pass through the first area and at least one second body part of the player may be required to pass through the second area for performing a playing action. Further, the first sensor 1702 may be configured for generating first sensor data based on detecting a passing of the at least one first body part of the player through the first sensor field of view. Further, the second sensor 1704 may be configured for generating second sensor data based on detecting a passing of the at least one second body part of the player through the second sensor field of view.

Further, the processing device 1706 may be communicatively coupled with the plurality of sensors 1702-1704. Further, the processing device 1706 may be configured for analyzing the first sensor data and the second sensor data. Further, the processing device 1706 may be configured for recognizing the at least one first body part of the player in the first area and the at least one second body part of the player in the second area. Further, the processing device 1706 may be configured for determining a presence of the at least one first body part in the first area and the at least one second body part in the second area under at least one criterion based on the recognizing. Further, the processing device 1706 may be configured for determining a correctness of the playing action based on the determining of the presence. Further, the processing device 1706 may be configured for generating at least one cueing command based on the determining. Further, the processing device 1706 may be configured for generating review data for the playing action using the first sensor data and the second sensor data based on the determining of the correctness.

Further, the storage device 1724 may be communicatively coupled with the processing device 1706. Further, the storage device 1724 may be configured for storing the review data. Further, the review data may include an indication of the correctness.

Further, the at least one output device 1708-1710 may be communicatively coupled with the processing device 1706. Further, the at least one output device 1708-1710 may be configured for producing at least one cue to inform the player about the correctness of the playing action based on the at least one cue command.

In further embodiments, the apparatus 1700 may include an apparatus body 1712 of the apparatus 1700. Further, the apparatus body 1712 may be disposable on at least one surface. Further, at least one of the plurality of sensors 1702-1704, the processing device 1706, and the at least one output device 1708-1710 may be disposed in the apparatus body 1712.

Further, in an embodiment, the plurality of sensors 1702-1704 may be pivotally disposed in the apparatus body 1712. Further, the plurality of sensors 1702-1704 may be configured to be pivoted between a plurality of sensor positions using a plurality of pivoting mechanisms 1714-1716. Further, the first sensor field of view covers the first area based on pivoting the first sensor 1702 to a first sensor position of the plurality of sensor positions. Further, the second sensor field of view covers the second area based on pivoting the second sensor 1704 to a second sensor position of the plurality of sensor positions. In further embodiments, the apparatus 1700 may include a communication device configured for receiving player data associated with the player from at least one input device. Further, the player data may include at least one measurement of the player. Further, the communication device may be communicatively coupled with the processing device 1706. Further, the processing device 1706 may be configured for analyzing the player data based on at least one playing action criterion. Further, the processing device 1706 may be configured for determining the first area and the second area based on the analyzing of the player data. Further, the processing device 1706 may be configured for generating a plurality of sensor commands for the plurality of sensors 1702-1704 based on the determining of the first area and the second area. Further, the processing device 1706 may be communicatively coupled with a plurality of actuators. Further, the plurality of actuators may be operationally coupled with the plurality of pivoting mechanisms 1714-1716. Further, the plurality of actuators may be configured for actuating the plurality of pivoting mechanisms 1714-1716 based on the plurality of sensor commands. Further, the plurality of pivoting mechanisms 1714-1716 may be configured for pivoting the plurality of sensors 1702-1704 based on the actuating.

In further embodiments, a plurality of laser devices 1718-1720 may be disposed in the apparatus body 1712. Further, a first laser device 1718 of the plurality of laser devices 1718-1720 may be configured for pointing the first area for identifying the first area. Further, a second laser device 1720 of the plurality of laser devices 1718-1720 may be configured for pointing the second area for identifying the second area. Further, the pivoting of the first sensor 1702 to the first sensor position may be based on the identifying of the first area. Further, the pivoting of the second sensor 1704 to the second sensor position may be based on the identifying of the second area.

In further embodiments, a support stand 1722 may be pivotally attached to a rear portion of the apparatus body 1712. Further, the support stand 1722 may be configured to be pivoted between a closed position and at least one open position in relation to the rear portion. Further, the support stand 1722 extends away from the rear portion in the at least one open position. Further, the support stand 1722 may be positioned on the rear portion in the closed position. Further, the support stand 1722 in the at least one open position may be configured for inclinably supporting the apparatus body 1712 in at least one inclination on the at least one surface. Further, the at least one inclination corresponds to the at least one open position.

In further embodiments, a communication device may be communicatively coupled with the storage device 1724. Further, the communication device may be configured for transmitting the review data to at least one device.

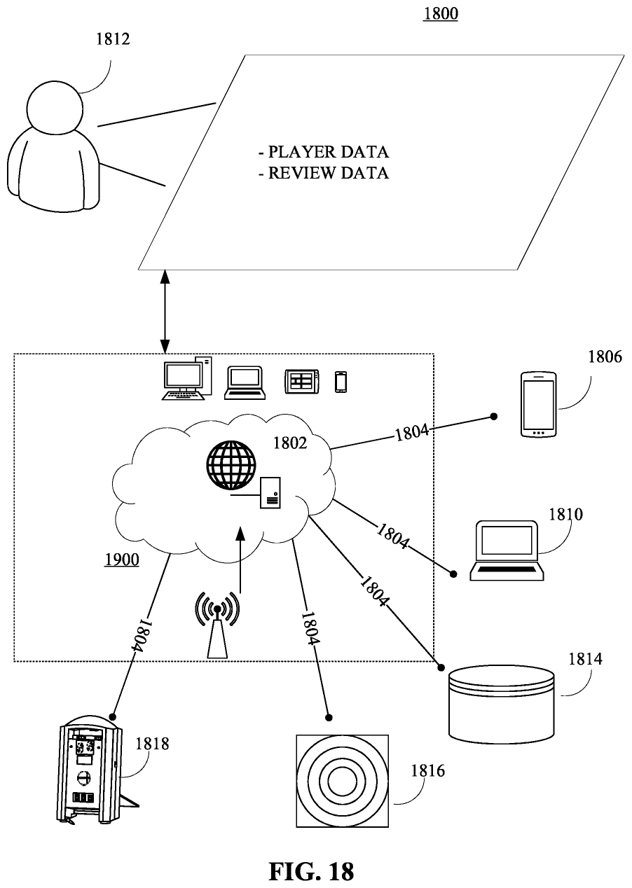

FIG. 18 is an illustration of an online platform 1800 consistent with various embodiments of the present disclosure. By way of non-limiting example, the online platform 1800 to facilitate correcting playing actions performed by a player for playing a game may be hosted on a centralized server 1802, such as, for example, a cloud computing service. The centralized server 1802 may communicate with other network entities, such as, for example, a mobile device 1806 (such as a smartphone, a laptop, a tablet computer, etc.), other electronic devices 1810 (such as desktop computers, server computers, etc.), databases 1814, sensors 1816, and an apparatus 1818 (such as the apparatus 100, apparatus 700, the apparatus 1700, etc.) over a communication network 1804, such as, but not limited to, the Internet. Further, users of the online platform 1800 may include relevant parties such as, but not limited to, end-users, administrators, service providers, service consumers, and so on. Accordingly, in some instances, electronic devices operated by the one or more relevant parties may be in communication with the platform.

A user 1812, such as the one or more relevant parties, may access online platform 1800 through a web based software application or browser. The web based software application may be embodied as, for example, but not be limited to, a website, a web application, a desktop application, and a mobile application compatible with a computing device 1900.

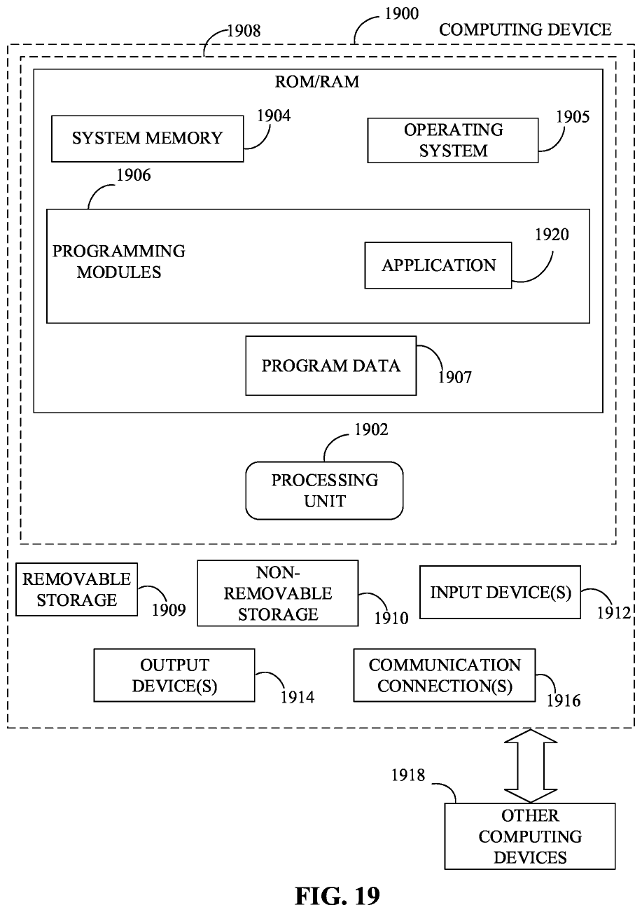

With reference to FIG. 19, a system consistent with an embodiment of the disclosure may include a computing device or cloud service, such as computing device 1900. In a basic configuration, computing device 1900 may include at least one processing unit 1902 and a system memory 1904. Depending on the configuration and type of computing device, system memory 1904 may comprise, but is not limited to, volatile (e.g. random-access memory (RAM)), non-volatile (e.g. read-only memory (ROM)), flash memory, or any combination. System memory 1904 may include operating system 1905, one or more programming modules 1906, and may include a program data 1907. Operating system 1905, for example, may be suitable for controlling computing device 1900's operation. In one embodiment, programming modules 1906 may include image-processing module, machine learning module. Furthermore, embodiments of the disclosure may be practiced in conjunction with a graphics library, other operating systems, or any other application program and is not limited to any particular application or system. This basic configuration is illustrated in FIG. 19 by those components within a dashed line 1908.

Computing device 1900 may have additional features or functionality. For example, computing device 1900 may also include additional data storage devices (removable and/or non-removable) such as, for example, magnetic disks, optical disks, or tape. Such additional storage is illustrated in FIG. 19 by a removable storage 1909 and a non-removable storage 1910. Computer storage media may include volatile and non-volatile, removable and non-removable media implemented in any method or technology for storage of information, such as computer-readable instructions, data structures, program modules, or other data. System memory 1904, removable storage 1909, and non-removable storage 1910 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1900. Any such computer storage media may be part of device 1900. Computing device 1900 may also have input device(s) 1912 such as a keyboard, a mouse, a pen, a sound input device, a touch input device, a location sensor, a camera, a biometric sensor, etc. Output device(s) 1914 such as a display, speakers, a printer, etc. may also be included. The aforementioned devices are examples and others may be used.

Computing device 1900 may also contain a communication connection 1916 that may allow device 1900 to communicate with other computing devices 1918, such as over a network in a distributed computing environment, for example, an intranet or the Internet. Communication connection 1916 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1904, including operating system 1905. While executing on processing unit 1902, programming modules 1906 (e.g., application 1920 such as a media player) may perform processes including, for example, one or more stages of methods, algorithms, systems, applications, servers, databases as described above. The aforementioned process is an example, and processing unit 1902 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. An apparatus for correcting playing actions performed by a player for playing a game, the apparatus comprising:
a plurality of sensors comprising a first sensor and a second sensor, wherein the first sensor is associated with a first sensor field of view and the second sensor is associated with a second sensor field of view, wherein the first sensor field of view covers a first area and the second sensor field of view covers a second area, wherein at least one first body part of the player is required to pass through the first area and at least one second body part of the player is required to pass through the second area for performing a playing action, wherein the first sensor is configured for generating first sensor data based on detecting a passing of the at least one first body part of the player through the first sensor field of view, wherein the second sensor is configured for generating second sensor data based on detecting a passing of the at least one second body part of the player through the second sensor field of view;
a processing device communicatively coupled with the plurality of sensors, wherein the processing device is configured for:
analyzing the first sensor data and the second sensor data;
recognizing the at least one first body part of the player in the first area and the at least one second body part of the player in the second area;
determining a presence of the at least one first body part in the first area and the at least one second body part in the second area under at least one criterion based on the recognizing;
determining a correctness of the playing action based on the determining of the presence; and
generating at least one cueing command based on the determining; and
at least one output device communicatively coupled with the processing device, wherein the at least one output device is configured for producing at least one cue to inform the player about the correctness of the playing action based on the at least one cue command.

2. The apparatus of claim 1 further comprising an apparatus body of the apparatus, wherein the apparatus body is disposable on at least one surface, wherein at least one of the plurality of sensors, the processing device, and the at least one output device is disposed in the apparatus body.

3. The apparatus of claim 2, wherein the plurality of sensors is pivotally disposed in the apparatus body, wherein the plurality of sensors is configured to be pivoted between a plurality of sensor positions using a plurality of pivoting mechanisms, wherein the first sensor field of view covers the first area based on pivoting the first sensor to a first sensor position of the plurality of sensor positions, wherein the second sensor field of view covers the second area based on pivoting the second sensor to a second sensor position of the plurality of sensor positions.

4. The apparatus of claim 3 further comprising a communication device configured for receiving player data associated with the player from at least one input device, wherein the player data comprises at least one measurement of the player, wherein the communication device is communicatively coupled with the processing device, wherein the processing device is further configured for:
analyzing the player data based on at least one playing action criterion;
determining the first area and the second area based on the analyzing of the player data; and
generating a plurality of sensor commands for the plurality of sensors based on the determining of the first area and the second area, wherein the processing device is communicatively coupled with a plurality of actuators, wherein the plurality of actuators is operationally coupled with the plurality of pivoting mechanisms, wherein the plurality of actuators is configured for actuating the plurality of pivoting mechanisms based on the plurality of sensor commands, wherein the plurality of pivoting mechanisms is configured for pivoting the plurality of sensors based on the actuating.

5. The apparatus of claim 3 further comprising a plurality of laser devices disposed in the apparatus body, wherein a first laser device of the plurality of laser devices is configured for pointing the first area for identifying the first area, wherein a second laser device of the plurality of laser devices is configured for pointing the second area for identifying the second area, wherein the pivoting of the first sensor to the first sensor position is based on the identifying of the first area, wherein the pivoting of the second sensor to the second sensor position is based on the identifying of the second area.

6. The apparatus of claim 2 further comprising a support stand pivotally attached to a rear portion of the apparatus body, wherein the support stand is configured to be pivoted between a closed position and at least one open position in relation to the rear portion, wherein the support stand extends away from the rear portion in the at least one open position, wherein the support stand is positioned on the rear portion in the closed position, wherein the support stand in the at least one open position is configured for inclinably supporting the apparatus body in at least one inclination on the at least one surface, wherein the at least one inclination corresponds to the at least one open position.

7. The apparatus of claim 2 further comprising a leveling vial disposed on a top portion of the apparatus body, wherein the leveling vial is configured for indicating a tilt of the apparatus body in relation to the at least one surface for adjusting the tilt of the apparatus body in relation to the at least one surface.

8. The apparatus of claim 7 further comprising one or more adjustable leveling feet disposed on a bottom portion of the apparatus body, wherein the one or more adjustable leveling feet is transitionable between a plurality of feet states, wherein the adjusting of the tilt of the apparatus body is based on transitioning the one or more adjustable leveling feet to at least one feet state of the plurality of feet states.

9. The apparatus of claim 1 further comprising a timer mechanism communicatively coupled with the plurality of sensors, wherein the timer mechanism is configured for:
registering a first time value based on the detecting of the passing of the at least one first body part of the player; and
registering a second time value based on the detecting of the passing of the at least one second body part of the player, wherein the processing device is communicatively coupled with the timer mechanism, wherein the processing device is further configured for:
analyzing the first time value and the second time value; and
determining a time interval between the first time value and the second time value based on the analyzing of the first time value and the second time value, wherein the at least one criterion comprises the time interval, wherein the determining of the presence of the at least one first body part of the player in the first area and the at least one second body part of the player in the second area under the at least one criterion is further based on the determining of the time interval.

10. The apparatus of claim 1, wherein the processing device is further configured for generating review data for the playing action using the first sensor data and the second sensor data based on the determining of the correctness, wherein the review data comprises an indication of the correctness, wherein the processing device communicatively coupled with a storage device, wherein the storage device is configured for storing the review data.

11. The apparatus of claim 10 further comprising a communication device communicatively coupled with the storage device, wherein the communication device is configured for transmitting the review data to at least one device.

12. The apparatus of claim 1 further comprising a storage device configured for retrieving correct playing action data associated with the playing action, wherein the processing device is communicatively coupled with the storage device, wherein the processing device is configured for:
analyzing the correct playing action data; and
determining the at least one criterion is further based on the analyzing the correct playing action data, wherein the determining of the presence of the at least one first body part of the player in the first sensor field of view and the at least one second body part of the player in the second sensor field of view under the at least one criterion is further based on the determining of the at least one criterion.

13. The apparatus of claim 12 further comprising a communication device configured for receiving player data associated with the player from at least one input device, wherein the player data comprises at least one measurement of the player, wherein the communication device is communicatively coupled with the processing device, wherein the processing device is further configured for analyzing the player data, wherein the determining of the at least one criterion is further based on the analyzing of the correct playing action data and the analyzing the player data.

14. An apparatus for correcting playing actions performed by a player for playing a game, the apparatus comprising:
a plurality of sensors comprising a first sensor and a second sensor, wherein the first sensor is associated with a first sensor field of view and the second sensor is associated with a second sensor field of view, wherein the first sensor field of view covers a first area and the second sensor field of view covers a second area, wherein at least one first body part of the player is required to pass through the first area and at least one second body part of the player is required to pass through the second area for performing a playing action, wherein the first sensor is configured for generating first sensor data based on detecting a passing of the at least one first body part of the player through the first sensor field of view, wherein the second sensor is configured for generating second sensor data based on detecting a passing of the at least one second body part of the player through the second sensor field of view;
a processing device communicatively coupled with the plurality of sensors, wherein the processing device is configured for:
analyzing the first sensor data and the second sensor data;
recognizing the at least one first body part of the player in the first area and the at least one second body part of the player in the second area;
determining a presence of the at least one first body part in the first area and the at least one second body part in the second area under at least one criterion based on the recognizing;
determining a correctness of the playing action based on the determining of the presence;
generating at least one cueing command based on the determining; and
generating review data for the playing action using the first sensor data and the second sensor data based on the determining of the correctness, wherein the review data comprises an indication of the correctness;
a storage device communicatively coupled with the processing device, wherein the storage device is configured for storing the review data; and
at least one output device communicatively coupled with the processing device, wherein the at least one output device is configured for producing at least one cue to inform the player about the correctness of the playing action based on the at least one cue command.

15. The apparatus of claim 14 further comprising an apparatus body of the apparatus, wherein the apparatus body is disposable on at least one surface, wherein at least one of the plurality of sensors, the processing device, and the at least one output device is disposed in the apparatus body.

16. The apparatus of claim 15, wherein the plurality of sensors is pivotally disposed in the apparatus body, wherein the plurality of sensors is configured to be pivoted between a plurality of sensor positions using a plurality of pivoting mechanisms, wherein the first sensor field of view covers the first area based on pivoting the first sensor to a first sensor position of the plurality of sensor positions, wherein the second sensor field of view covers the second area based on pivoting the second sensor to a second sensor position of the plurality of sensor positions.

17. The apparatus of claim 16 further comprising a communication device configured for receiving player data associated with the player from at least one input device, wherein the player data comprises at least one measurement of the player, wherein the communication device is communicatively coupled with the processing device, wherein the processing device is further configured for:
analyzing the player data based on at least one playing action criterion;
determining the first area and the second area based on the analyzing of the player data; and
generating a plurality of sensor commands for the plurality of sensors based on the determining of the first area and the second area, wherein the processing device is communicatively coupled with a plurality of actuators, wherein the plurality of actuators is operationally coupled with the plurality of pivoting mechanisms, wherein the plurality of actuators is configured for actuating the plurality of pivoting mechanisms based on the plurality of sensor commands, wherein the plurality of pivoting mechanisms is configured for pivoting the plurality of sensors based on the actuating.

18. The apparatus of claim 16 further comprising a plurality of laser devices disposed in the apparatus body, wherein a first laser device of the plurality of laser devices is configured for pointing the first area for identifying the first area, wherein a second laser device of the plurality of laser devices is configured for pointing the second area for identifying the second area, wherein the pivoting of the first sensor to the first sensor position is based on the identifying of the first area, wherein the pivoting of the second sensor to the second sensor position is based on the identifying of the second area.

19. The apparatus of claim 15 further comprising a support stand pivotally attached to a rear portion of the apparatus body, wherein the support stand is configured to be pivoted between a closed position and at least one open position in relation to the rear portion, wherein the support stand extends away from the rear portion in the at least one open position, wherein the support stand is positioned on the rear portion in the closed position, wherein the support stand in the at least one open position is configured for inclinably supporting the apparatus body in at least one inclination on the at least one surface, wherein the at least one inclination corresponds to the at least one open position.

20. The apparatus of claim 14 further comprising a communication device communicatively coupled with the storage device, wherein the communication device is configured for transmitting the review data to at least one device.
